(19) United States
(12) Patent Application Publication
(10) Pub. No.: US 2024/0319367 A1
(43) Pub. Date: Sep. 26, 2024

(54) Ranging device with angle reporting and angle reporting method thereof

(71) Applicant: Seer Microelectronics, Inc., Hsinchu county (TW)

(72) Inventors: Wei-Cheng Chen, Hsinchu county (TW); Chih-Han Yen, Hsinchu county (TW)

(21) Appl. No.: 18/510,744

(22) Filed: Nov. 16, 2023

Related U.S. Application Data
(60) Provisional application No. 63/384,002, filed on Nov. 16, 2022.

(51) Int. Cl. G01S 17/42

(52) U.S. Cl. CPC G01S 17/42

(57) ABSTRACT

The present application provides a ranging device with angle reporting and the angle reporting method thereof. The ranging device comprises a ranging module and a control module. The control module is coupled to the ranging module and acquires angle information. The control module acquires a plurality of distance sensing values from the ranging module and generates a packet according to the distance sensing value and the angle information.

### FIELD OF THE INVENTION

The present application related to a ranging device and a method thereof, in particular to a ranging device with angle reporting and an angle reporting method thereof.

### BACKGROUND OF THE INVENTION

A distance sensor is used to measure the distance between itself and the environment. It is installed in an electronic device to allow the electronic device to acquire the surrounding conditions and developed to many applications. Therefore, distance sensors are indispensable equipment for current electronic devices and are widely applied to the fields such as mobile phones, automobiles, smart robots, and robot vacuums.

The ranging equipment of some electronic devices has a rotational ranging scanning function, such as the lidar on a robot vacuum. In addition to a distance sensor, this type of ranging equipment also has an angle sensor with a rotating stage, so that the distance and angle information may be acquired when the device is rotated for constructing two- or three-dimensional space. The reporting method of the ranging equipment according to the prior art first uses the angle sensor to sense the rotation of the ranging equipment. After acquiring the angle information, the distance sensor starts to sense the distance to the surrounding objects. In other words, the method according to the prior art may not make use of the ranging time efficiently, which affects the computing efficiency.

Accordingly, how to solve the reporting problem as described above has been become an urgent technical issue of the field.

### SUMMARY OF THE INVENTION

An objective of the present application is to provide a ranging device with angle reporting and the angle reporting method thereof. The angle and the distance are sensed, respectively. The distance is sensed while sensing the angle. Then, a ranging packet with the angle value is generated for improving the computing efficiency of ranging.

The present application provides a ranging device with angle reporting, which comprises a ranging module and a control module. The control module is coupled to the ranging module and acquires an angle information. The control module acquires a plurality of distance sensing values from the ranging module and generates a packet according to the distance sensing value and the angle information.

The present application provides an angle reporting method, which is applied to a ranging device. When the ranging device is in operating, the ranging device is driven to acquire a plurality of distance sensing values and an angle information. Then, the ranging device generates a packet according to the distance sensing value and the angle information.

### BRIEF DESCRIPTION OF DRAWINGS

FIG. 1 shows a schematic diagram of the ranging device with angle reporting according to an embodiment of the present application;

FIG. 2 shows a flowchart of the angle reporting method according to another embodiment of the present application;

FIG. 3 shows a timing diagram of angle reporting according to an embodiment of the present application;

FIG. 4 shows a schematic diagram of angle reporting when the timing of the sensing sequence is earlier than the timing of the periodic sequence according to an embodiment of the present application; and

FIG. 5 shows a schematic diagram of angle reporting when the timing of the sensing sequence is later than the timing of the periodic sequence according to an embodiment of the present application.

### DETAILED DESCRIPTION OF THE INVENTION

In order to make the structure and characteristics as well as the effectiveness of the present application to be further understood and recognized, the detailed description of the present application is provided as follows along with embodiments and accompanying figures.

In the specifications and subsequent claims, certain words are used for representing specific devices. A person having ordinary skill in the art should know that hardware manufacturers might use different nouns to call the same device. In the specifications and subsequent claims, the differences in names are not used for distinguishing devices. Instead, the differences in functions are the guidelines for distinguishing. In the whole specifications and subsequent claims, the word “comprising” is an open language and should be explained as “comprising but not limited to”. Besides, the word “couple” includes any direct and indirect electrical connection. Thereby, if the description is that a first device is coupled to a second device, it means that the first device is connected electrically to the second device directly, or the first device is connected electrically to the second device via other device or connecting means indirectly.

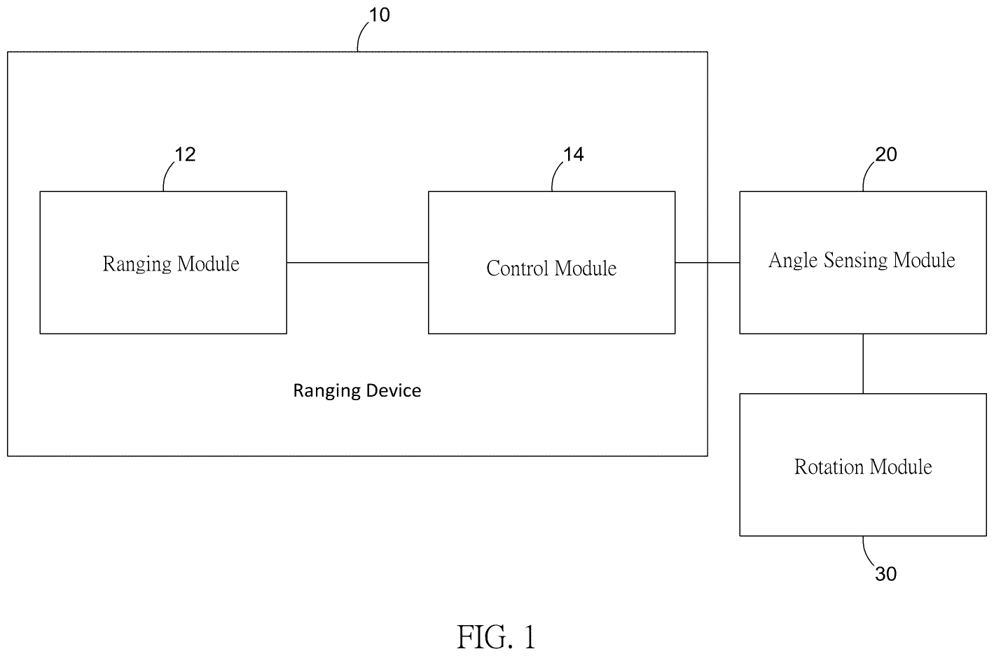

Please refer to FIG. 1, which shows a schematic diagram of the ranging device with angle reporting according to an embodiment of the present application. As shown in the figure, the ranging device 10 comprises a ranging module 12 and a control module 14. The control module 14 is coupled to the ranging module 12 and an angle sensing module 20. The angle sensing module 20 is disposed in a rotation module 30. The ranging device 10 is disposed on a rotation platform (not shown in the figure) of the rotation module 30. The base (not shown in the figure) of the rotation module 30 is further disposed at an electronic device (not shown in the figure), so that the ranging device 10 may perform rotation ranging with respect to the electronic device (for example, a robot vacuum). The angle sensing module 20 is used for sensing the rotation of the rotation module 30, generating angle information, and providing the angle information to the control module 14. The control module 14 then acquires the rotational angle and rotational speed of the rotation module 30 according to the angle information.

The ranging module 12 is used for sensing the distance to an object, in other words, the distance between the sensing electronic device and an object, and generating a plurality of distance sensing values and then providing the distance sensing values. The control module 14 acquires the plurality of distance sensing values from the ranging module 12 according to a periodic sequence. The control module 14 generates a packet according to the plurality of distance sensing values and the angle information. In the period when the angle sensing module 20 sensing rotation, the ranging module 12 performs ranging for providing the plurality of distance sensing values, which is different from the ranging device according to the prior art that performs ranging after the information from the angle sensing module is received. Consequently, the ranging device 10 may configure the operating time of the control module 14 efficiently. According to an embodiment of the present application, the control module 14 generates a distance measurement value according to the plurality of distance sensing values. The control module 14 generates a packet according to the distance measurement value and the angle information. The packet includes the distance measurement value and the corresponding angle value. The packet may further include other information such as the angular velocity value.

According to the present embodiment, the ranging device 10 may be a lidar or other types of distance sensing devices. The ranging module 12 may be a ranging module of various types, for example, a single photon avalanche diode (SPAD) ranging module, a photo diode (PD) ranging module, or an avalanche photo diode (APD) ranging module. The control module 14 may be a microprocessor, a field programmable gate array (FPGA), or other processors. The angle sensing module 20 may be an optical encoder or a magnetic encoder. The rotation module 30 may be a rotation platform or a galvanometer.

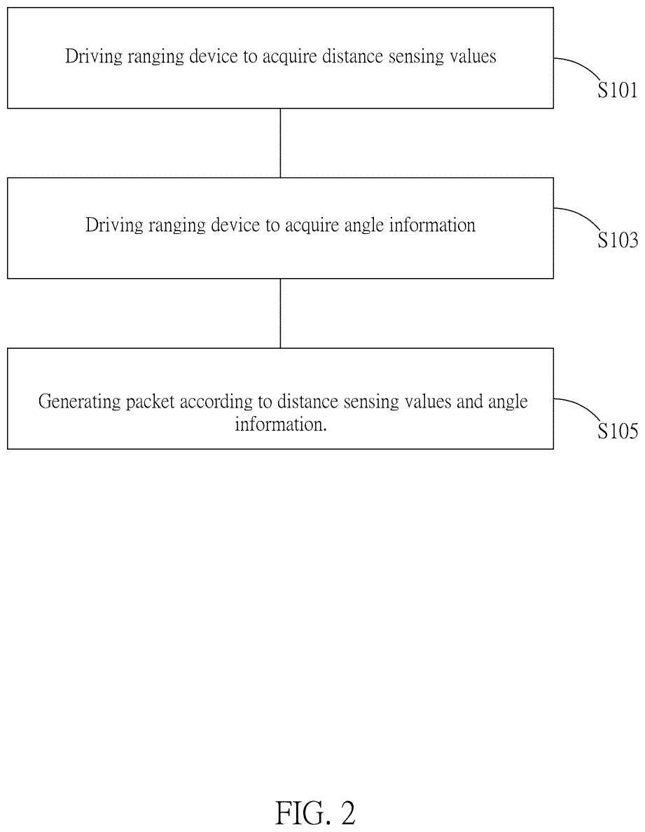

Please refer to FIG. 2, which shows a flowchart of the angle reporting method according to another embodiment of the present application. According to another embodiment of the present application, an angle reporting method is provided. The method may be applied to a ranging device, and comprises the following steps:
S101: Driving ranging device to acquire distance sensing values;
S103: Driving ranging device to acquire angle information;
S105: Generating packet according to distance sensing values and angle information.

According to another embodiment, the above angle reporting method may further comprise the following steps: driving the ranging device to provide the plurality of distance sensing values in the period when an angle sensing module senses rotation; acquiring the distance sensing values according to a periodic sequence; generating a distance measurement value according to the distance sensing values; and generating the packet according to the distance measurement value and the angle information, and the packet including the distance measurement value and an angle value.

According to another embodiment, a sensing sequence for generating the angle information in the angle reporting method as described above and the periodic sequence are independent.

According to another embodiment, when the timing of the sensing sequence in generating the angle information in the angle reporting method is earlier than the timing of the periodic sequence, the number of the acquired distance sensing values is reduced for generating the corresponding distance measurement value.

According to another embodiment, when the timing of the sensing sequence for generating the angle information in the angle reporting method is earlier than the timing of the periodic sequence, the packet is generated according to the next new angle information and the next new distance measurement value.

According to another embodiment, when the timing of the sensing sequence for generating the angle information in the angle reporting method is later than the timing of the periodic sequence, stop acquiring the distance sensing values.

According to another embodiment, the ranging device using the angle reporting method as described above configures the angle value according to the time difference between the generation time corresponding to at least one of the distance sensing values or the distance measurement value and the receiving time of the angle information.

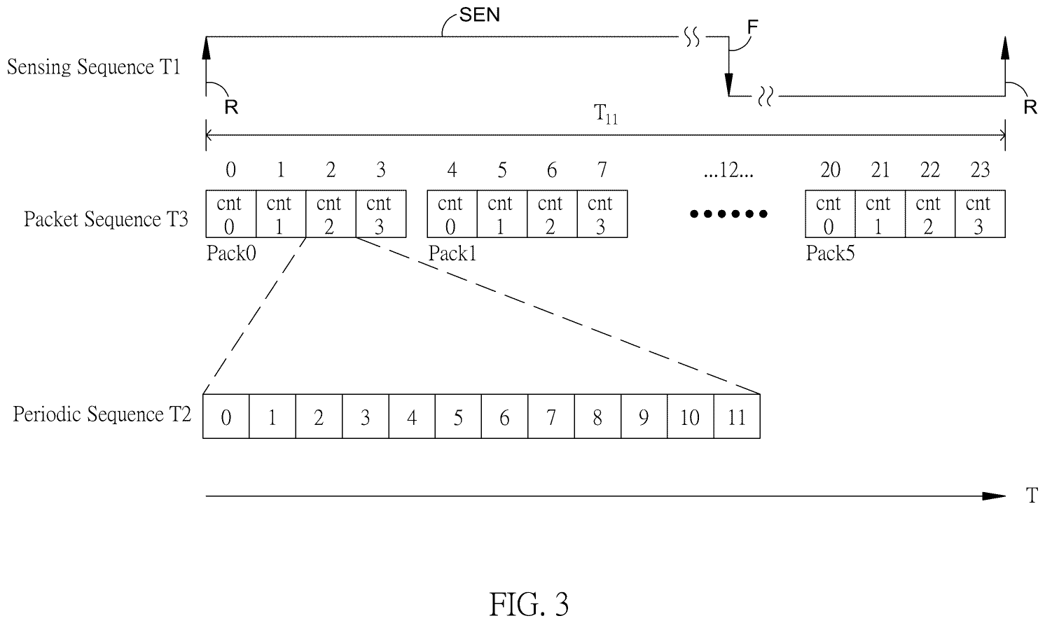

In the following, the ranging device 10 will be used for illustration. Nonetheless, the angle reporting method as described above also has identical or similar technical effects. Please refer to FIG. 3, which shows a sequence diagram of angle reporting according to an embodiment of the present application. The sensing sequence T1 represents the timing of the angle sensing module 20 sensing the rotation, which is also the timing of generating the angle information. The periodic sequence T2 represents the timing of the control module 14 acquiring the distance sensing values from the ranging module 12, which also the timing of the ranging module 12 sensing the distance. The packet sequence T3 represents the timing of the control module 14 generating the packet. According to an embodiment of the present application, when the angle sensing module 20 performs sensing, it will generate the angle information and provide it to the control module 14. The angle information may be, for example, a sensing signal SEN, which may be an interrupt signal. The timing of the sensing signal SEN may represent the sensing sequence T1.

A signal cycle T₁₁ of the sensing signal SEN may represent that the rotation module 30 rotates a specific angle, for example, 24 degrees. Thereby, a half signal cycle T₁₁/2 of the sensing signal SEN may represent that the rotation module 30 rotates a half of the specific angle, for example, 12 degrees. Take a signal cycle T₁₁ representing 24 degrees for example. If the control module 14 receives the sensing signal SEN until 15 signal cycles T₁₁, it means that the rotation module 30 rotates 360 degrees. Given the rotation module 30 is rotated at a fixed rotation rate, when the control module 14 receives the rising edge R of the sensing signal SEN, start counting or timing to obtain the rotation angle of the rotation module 30. When the falling edge of the sensing signal SEN is received, the control module 14 may obtain that the rotation module 30 rotates 12 degrees. Likewise, when the control module 14 receives the rising edge R of the sensing signal SEN again, it is known that the rotation module 30 rotates 24 degrees.

According to an embodiment of the present application, when the angle sensing module 20 generates the sensing signal SEN, a notification signal as the angle information may be transmitted to the control module 14 at the timing corresponding to each rising edge R and each falling edge F. Thereby, the sensing signal SEN may not be provided to the control module 14. Then, the control module 14 performs counting or timing to obtain the rotation angle of the rotation module 30. According to an embodiment of the present application, the control module 14 resets counting or timing for every 15 signal cycles. The signal cycle T₁₁ of the sensing signal SEN may be designed according to requirements. For example, a signal cycle T₁₁ may represent 12 or 6 degrees. There are many types of angle sensing modules 20, leading to different methods for sensing angle. The above description is an embodiment of the operation of the angle sensing module 20 according to the present application, not used for limiting the scope of the present application. In the sensing period, the angle sensing module 20 according to the present application generates the angle information to the control module 14. Then control module 14 may determine the rotation angle of the rotation module 30 accordingly.

Please refer to FIG. 3 again. The control module 14 acquires the distance sensing values from the ranging module 12 according to the periodic sequence T2 and generates the distance measurement value according to the distance sensing values, the distance measurement value represents the distance between the electronic device and the object. According to an embodiment of the present application, the signal timing of a periodic pulse signal may be used as the periodic sequence T2. According to the present embodiment, 12 pulses of the periodic pulse signal as a cycle as an example. Nonetheless, the present application is not limited to the embodiment. The control module 14 acquires 11 distance sensing values from the ranging module 12 according to the first 11 pulses (0˜10) of the pulse signal and calculates the distance measurement value in the 12th pulse cycle (11) according to the 11 distance sensing values. For example, the average value of the 11 distance sensing values may be used as the distance measurement value. Alternatively, the maximum and minimum distance sensing values are ignored and the average value of the rest is used as the distance measurement value. Alternatively, setting different weights and performing weighted calculations on these distance sensing values to obtain distance measurements. The above methods are embodiments of generating the distance measurement value by the control module 14 according to the present application. The present application is not limited to the embodiments. According to an embodiment of the present application, the control module 14 may generate the periodic pulse signal. Alternatively, the periodic pulse signal may be generated by other circuits. According to an embodiment of the present application, the sensing sequence T1 and the periodic sequence T2 may be independent.

The control module 14 generates the packet according to the acquired angle values and the distance measurement value. According to an embodiment of the present application, a packet includes four indexes (cnt0˜cnt3). Each of indexes includes one or more angle value and the corresponding distance measurement value or other information. The above packet is an embodiment of the present application. The present application is not limited to the embodiment. The number of indexes may be designed according to requirements. When the angle sensing module 20 senses the rotation of the rotation module 30, the ranging module 12 performs ranging. When the control module 14 acquires the angle value according to the angle information, it also acquires the distance measurement value for generating the packet. Thereby, the operating time of the control module 14 may be configured efficiently. It also avoids inability of returning angle value and distance measurement values since the distance to the object may not be measured at the proper time.

According to an embodiment, the control module 14 configures the angle value according to the time difference between a generation time Tg corresponding to at least one of the distance sensing values or the distance measurement value and the receiving time Tangle of the angle information. For example, if the rotation rate of the rotation module 30 is 5 revolutions per second (RPS) and the measurement angle is 1 degree. Since the rotation angle per second of the rotation module 30 is 5×360°=1800°, the time to rotate 1 degree is 1/1800=555.55 ms. Thereby, when the ranging device 10 is set to perform rotation ranging, the ranging device 10 generates 1800 distance measurement values per second (the reporting rate is noted as 1.8 KHz). That is, each of the time intervals between distance measurement values is the reciprocal of the reporting rate (1/1800=555.55 ms). In other words, when the generation time Tg differs the receiving time Tangle by 555.55 ms, it means that the angle value of the measurement point is increased by 1 degree compared to the corresponding angle value of the receiving time Tangle. Based on the above method, the ranging device 10 may use the timing method to acquire the time difference between the generation time Tg and the receiving time Tangle and hence determining the angle value.

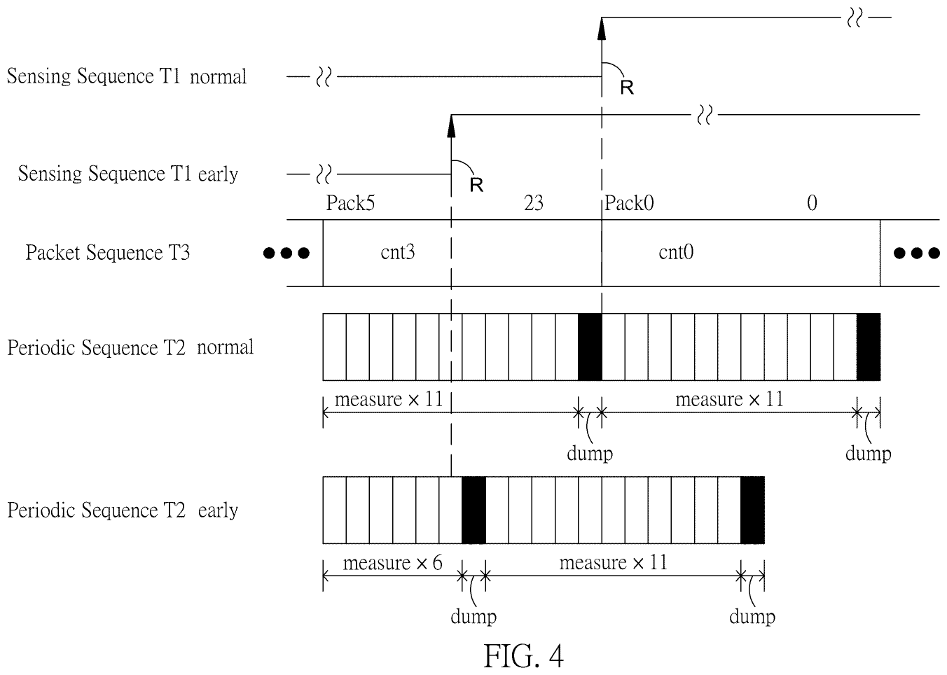

Please refer to FIG. 4, which shows a schematic diagram of angle reporting when the timing of the sensing sequence is earlier than the timing of the periodic sequence according to an embodiment of the present application. The embodiment in FIG. 4 is the same as the one in FIG. 3. The signal cycle T₁₁ of the sensing signal SEN means that the rotation module 30 rotates 24 degrees. The signal timing of the periodic pulse signal acts as the periodic sequence T2. 12 pulses of the periodic pulse signal form a cycle. At the normal condition, the angle sensing module 20 transmits the notification signal to the control module 14 at the timing of the second rising edge R of the sensing signal SEN. The control module 14 acquires the angle value to be 24 according to the notification signal (angle information) and acquires 11 distance sensing values (measure×11) from the ranging module 12 according to the 11 pulses of periodic pulse signal. Besides, the control module 14 determines the distance measurement value in the 12th pulse cycle according to the 11 distance sensing values. Then the distance measurement value may be provided (dump). Thereby, the angle value and the distance measurement value may be filled into the fourth index (cnt3) of the sixth packet (Pack5) and become as the content of the fourth index.

Please refer to FIG. 4 again. If the angle sensing module 20 transmits the notification signal to the control module 14 at the timing of the second rising edge R of the sensing signal SEN, the control module 14 acquires the angle value. Nonetheless, the control module 14 acquires 6 distance sensing values (measure×6) from the ranging module 12 according to 6 pulses of the periodic pulse signal. This condition means that the timing of the sensing sequence T1 is earlier than the timing of the periodic sequence T2. According to an embodiment of the present application, the control module 14 determines the distance measurement value according to the acquired 6 distance sensing values. Namely, the control module 14 reduces the number of the acquired distance sensing values. In addition, the angle value and the distance measurement values are used as the content of the fourth index (cnt3) of the sixth packet (Pack5).

According to an embodiment of the present application, when the control module 14 receives the notification signal, it is about to write the third index (cnt2) into the packet, meaning that the timing of the sensing sequence T1 is earlier than the timing of the periodic sequence T2. The control module 14 fills the acquired distance measurement value into the third index (cnt2) and the fourth index (cnt3) of the sixth packet (Pack5). In other words, the distance measurement values corresponding to the angle 23 and angle 24 are identical. According to an embodiment of the present application, when the control module 14 receives the notification signal, it is about to write the first index (cnt0) or the second index (cnt1), meaning that the timing of the sensing sequence T1 is even earlier than the timing of the periodic sequence T2. The control module 14 fills the acquired distance measurement value into the first index (cnt0), leaves the second index (cnt1) to the fourth index (cnt3) blank, meaning that the distances corresponding to some angles are ignored. According to the next new angle information (next new angle value) and the next new distance measurement value, the first index of the next packet is written. According to an embodiment of the present application, in the above conditions, the control module 14 may fill the acquired distance measurement values into the first index (cnt0) to the fourth index (cnt3). The above reporting methods are the embodiments of the present application. The present application is not limited to the embodiments. Instead, the method may be adapted according to the requirements.

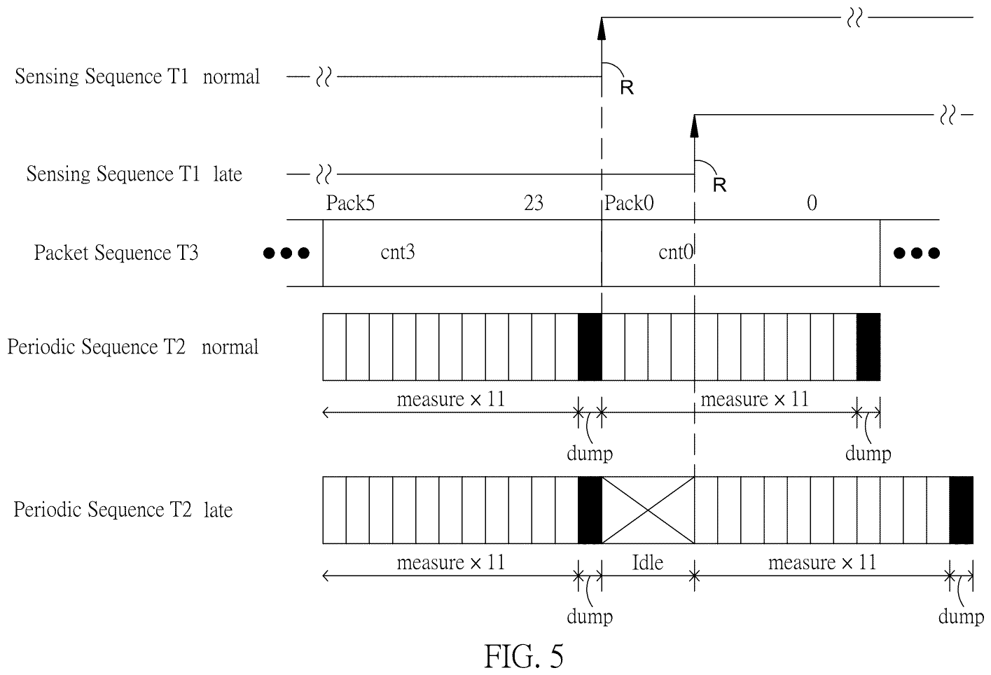

Please refer to FIG. 5, which shows a schematic diagram of angle reporting when the timing of the sensing sequence is later than the timing of the periodic sequence according to an embodiment of the present application. The embodiment in FIG. 5 is the same as the one in FIG. 3. The signal cycle T₁₁ means that the rotation module 30 rotates 24 degrees. The signal timing of the periodic pulse signal acts as the periodic sequence T2. 12 pulses of the periodic pulse signal form a cycle. When the control module 14 does not receive the notification signal, the control module 14 already acquires 11 distance sensing values (measure×11) from the ranging module 12 according to the 11 pulses of periodic pulse signal. Besides, the control module 14 determines the distance measurement value according to the 11 distance sensing values. Then the distance measurement value may be provided (dump). In other words, the timing of the sensing sequence T1 is later than the timing of the periodic sequence T2. According to an embodiment of the present application, the control module 14 stops acquiring the distance sensing values (Idle) and further controls the ranging module 12 to stop sensing. Once the control module 14 receives the notification signal, it controls the ranging module 12 to perform sensing and acquire the distance sensing values.

The present application provides a ranging device with angle reporting and the angle reporting method thereof. During the period of sensing rotation, the ranging device is also performed for providing the distance sensing values and generating the packet at the proper time according to the angle information and the distance sensing values. Thereby, the operating time of the control module may be configured efficiently. It also avoids inability of returning angle value and distance measurement values since the distance to the object may not be measured at the proper time.

Accordingly, the present application conforms to the legal requirements owing to its novelty, nonobviousness, and utility. However, the foregoing description is only embodiments of the present application, not used to limit the scope and range of the present application. Those equivalent changes or modifications made according to the shape, structure, feature, or spirit described in the claims of the present application are included in the appended claims of the present application.

1. A ranging device with angle reporting, comprising:
a ranging module, proving a plurality of distance sensing values; and
a control module, coupled to said ranging module, acquiring said plurality of distance sensing values and an angle information, and generating a packet according to said plurality of distance sensing values and said angle information.

2. The ranging device of claim 1, wherein said ranging module provides said plurality of distance sensing values in a period when an angle sensing module senses rotation; said control module acquires said plurality of distance sensing values from said ranging module according to a periodic sequence and generates a distance measurement value according to said acquired plurality of distance sensing values, said control module generates said packet according to said distance measurement value and said angle information, and said packet includes said distance measurement value and an angle value.

3. The ranging device of claim 2, wherein a sensing sequence for said angle sensing module generating said angle information and said periodic sequence are independent.

4. The ranging device of claim 2, wherein when a timing of a sensing sequence for said angle sensing module generating said angle information is earlier than a timing of said periodic sequence, said control module reduces the number of said plurality of distance sensing values acquired by said control module and generates said distance measurement value.

5. The ranging device of claim 2, wherein when a timing of a sensing sequence for said angle sensing module generating said angle information is earlier than a timing of said periodic sequence, said control module generates said packet according to a next new angle information and a next new distance measurement value.

6. The ranging device of claim 2, wherein when a timing of a sensing sequence for said angle sensing module generating said angle information is later than a timing of said periodic sequence, said control module stops acquiring said plurality of distance sensing values.

7. The ranging device of claim 2, wherein said control module configures said angle value according to a time difference between a generation time corresponding to at least one of said plurality of distance sensing values or said distance measurement value and a receiving time of said angle information.

8. An angle reporting method, applied to a ranging device, comprising:
driving said ranging device to acquire a plurality of distance sensing values;
driving said ranging device to acquire an angle information; and
generating a packet according to said plurality of distance sensing values and said angle information.

9. The angle reporting method of claim 8, further comprising:
driving said ranging device to provide said plurality of distance sensing values in the period when an angle sensing module senses rotation; and
acquiring said plurality of distance sensing values according to a periodic sequence, generating a distance measurement value according to said acquired plurality of distance sensing values, generating said packet according to said distance measurement value and said angle information, and said packet including said distance measurement value and an angle value.

10. The angle reporting method of claim 9, wherein a sensing sequence for generating said angle information and said periodic sequence are independent.

11. The angle reporting method of claim 9, wherein when a timing of a sensing sequence for generating said angle information is earlier than a timing of said periodic sequence, reduce the number of said acquired plurality of distance sensing values and generate said distance measurement value.

12. The angle reporting method of claim 9, wherein when a timing of a sensing sequence for generating said angle information is earlier than a timing of said periodic sequence, generate said packet according to a next new angle information and a next new distance measurement value.

13. The angle reporting method of claim 9, wherein when a timing of a sensing sequence for generating said angle information is later than a timing of said periodic sequence, stop acquiring said plurality of distance sensing values.

14. The angle reporting method of claim 9, wherein said ranging device configures said angle value according to the time difference between a generation time corresponding to at least one of said plurality of distance sensing values or said distance measurement value and a receiving time of said angle information.
